(19) United States
(12) Patent Application Publication
(10) Pub. No.: US 2014/0173532 A1
(43) Pub. Date: Jun. 19, 2014

(54) DISPLAY CONTROL APPARATUS, DISPLAY CONTROL METHOD, AND STORAGE MEDIUM

(71) Applicant: CANON KABUSHIKI KAISHA, Tokyo (JP)

(72) Inventors: Motoki Ikeda, Tokyo (JP); Hiroshi Sumio, Tokyo (JP); Masahito Yamamoto, Yokohama-shi (JP); Yoichi Kashibuchi, Kawasaki-shi (JP)

(73) Assignee: CANON KABUSHIKI KAISHA, Tokyo (JP)

(21) Appl. No.: 14/104,311

(22) Filed: Dec. 12, 2013

(30) Foreign Application Priority Data
Dec. 19, 2012 (JP) 2012-277304
Dec. 3, 2013 (JP) 2013-250511

(51) Int. Cl. G06F 3/0488

(52) U.S. Cl. CPC G06F 3/0488
USPC 715/863

(57) ABSTRACT

In display apparatuses each including a touch UI, some of them correct or suppress the direction of display position shift in swipe operation. It is, however, inconvenient that sometimes the correction or suppression is performed at an undesired timing. The display position shift is suppressed depending on an attribute of a displayed object.

### BACKGROUND OF THE INVENTION

1. Field of the Invention

The present invention relates to a display control apparatus, a display control method, and a storage medium.

2. Description of the Related Art

Conventionally, in a case where a page image of a document having a large number of pixels is displayed on a comparatively small display apparatus such as a personal computer, a PDA, a smart phone, and a tablet, there is employed a method of displaying a part of the page image sequentially. Generally, the page image is configured with plural objects such as a text, a caption, a figure, a photograph, and a table. A user needs to repeat operation such as shift of a display position (scroll) and scaling so that a desired range of the page is displayed sequentially on the display apparatus, in order to read on a document along with these objects.

Such operation of the display position shift or the scaling is performed by operation of an operation input device such as a switch, a wheel, a trackball, a joystick, and a touch screen. In particular, recently, an apparatus using a highly precise touch screen has been used widely. Such an apparatus provides direct operation (direct manipulation) such as the display position shift in any of vertical, horizontal, and diagonal directions by swipe operation or flick operation, and the scaling by pinch-out or pinch-in operation.

Moreover, in Japanese Patent Laid-Open No. 2011-70554, there is disclosed a technique of correcting the shift direction of the display position by the swipe operation into the horizontal direction or the vertical direction. This technique learns misalignment of the swipe operation in the horizontal direction or the vertical direction which is caused depending on an individual difference and an operation position of an operator, and reflects the learning in correcting the display position shift operation.

Further, Web browser installed on iPad (registered brand) or iPhone (registered brand) of Apple Incorporated employs a technique of suppressing and fixing the display position shift by the swipe operation in the horizontal direction or the vertical direction. That is, initial movement of the swipe operation is operated precisely in the horizontal direction or the vertical direction, and thereby the following display position shift by the swipe operation until a finger is released is suppressed only in the horizontal direction or only in the vertical direction. For example, in the case of reading on a text, and the like, preferably the display position is shifted along a text direction. Here, the text direction is a direction from the left to the right in the horizontal direction in the case of Japanese horizontal writing as in the original specification, for example. The above technique of performing the correction or suppression of display position shift is convenient for such a case, since the display position shift is reduced in the perpendicular direction to the desired direction (text direction).

However, in the technique disclosed in Japanese Patent Laid-Open No. 2011-70554 and the technique employed in iPad (registered brand) and iPhone (registered brand), the correction or suppression of the display position shift is activated regardless of the type of the object. For example, in a case where an object displayed on the display apparatus is a photograph capturing a person or a landscape, the display position is desired to be shifted according to the movement of a finger instructing the swipe operation. However, a user sometimes activates correction or suppression unintentionally, and in this case, the user is unable to shift the display position in a desired direction.

### SUMMARY OF THE INVENTION

A display control apparatus according to the present invention includes a control unit configured to control display position shift of an image expressed by image data depending on an attribute of an object included in the image data.

According to the present invention, it is possible to perform appropriate shift processing of a display position depending on an object to be displayed.

Further features of the present invention will become apparent from the following description of exemplary embodiments (with reference to the attached drawings).

### BRIEF DESCRIPTION OF THE DRAWINGS

FIG. 1 is a block diagram showing a configuration example of a mobile information terminal;

FIG. 2 is a block diagram showing a configuration concept of an application program;

FIG. 3 is a conceptual diagram showing a gesture event name and information to be transmitted to a gesture event processing unit in a case where each event is generated;

FIG. 4 is a flowchart showing a procedure of initial display processing of a touch UI;

FIG. 5 is a screen view showing a display example of the touch UI in the mobile information terminal;

FIG. 6 is a diagram showing the relationship of FIGS. 6A and 6B;

FIGS. 6A and 6B indicate a flowchart showing a procedure of display position shift processing in a display control apparatus;

FIG. 7 is a flowchart showing a procedure of shift suppression determination processing of a character attribute object;

FIG. 8 is a flowchart showing a procedure of shift suppression determination processing of a table attribute object;

FIG. 9 is a flowchart showing a procedure of shift suppression determination processing of a graphic attribute object;

FIG. 10A is a diagram showing an example of a bar graph as a graphic attribute object;

FIG. 10B is a diagram showing an example of a band graph as a graphic attribute object;

FIG. 11 is a flowchart showing a procedure of shift range limitation processing;

FIG. 12 is a screen view showing a display example of the touch UI in a partial region display mode of the mobile information terminal;

FIG. 13A and FIG. 13B are screen views showing display examples of the touch UI in the mobile information terminal;

FIG. 14A to FIG. 14C are screen views showing display examples of the touch UI in the mobile information terminal;

FIG. 15 is a diagram showing the relationship of FIGS. 15A and 15B;

FIGS. 15A and 15B indicate a flowchart showing a procedure of display position shift processing; and

FIG. 16 is a screen view showing a display example of the touch UI in the mobile information terminal.

### DESCRIPTION OF THE EMBODIMENTS

Hereinafter, embodiments for carrying out the present invention will be explained by the use of the drawings.

### Embodiment 1

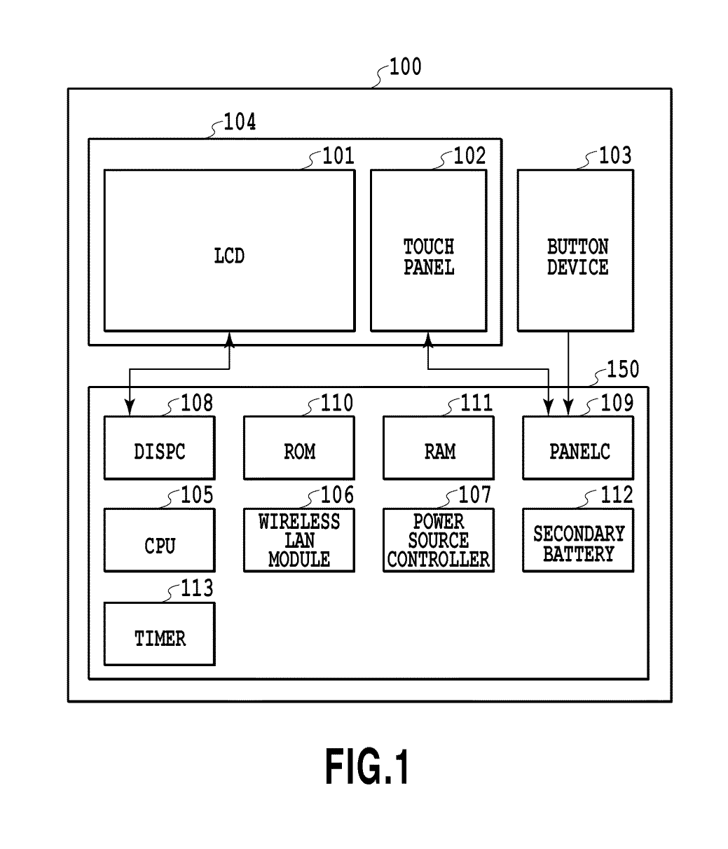

FIG. 1 is a block diagram showing a configuration example of a mobile information terminal 100. In the present embodiment, while an example of a mobile information terminal will be explained as an example of a display control apparatus, the present embodiment may be applied to an apparatus having a comparatively small display screen such as an MFP (Multifunction Peripheral), for example. Further, also in a general purpose computer having a comparatively large display screen, there is considered a use case where display position shift is necessary for a page image in a display screen. In such a case, the display control apparatus may be the general purpose computer.

The mobile information terminal 100 includes a main board 150, an LCD 101, a touch panel 102, and a button device 103. Further, the LCD 101 and the touch panel 102 are collectively called a touch UI 104.

The main board 150 has a CPU 105, a wireless LAN module 106, a power source controller 107, a display controller (DISPC) 108, and a panel controller (PANELC) 109. Further, the main board 150 has a ROM 110, a RAM 111, a secondary battery 112, and a timer 113. Then, the respective modules are connected with one another by a bus (not shown in the drawing).

The CPU 105 is a controller for controlling this mobile information terminal 100 as a whole. The CPU 105 controls each of the modules connected to the bus. The CPU 105 activates an OS (Operating System) using a boot program stored in the ROM 110. On this OS, the CPU 105 executes an application program stored in the same ROM 110. This application program is a program browsing the contents of application image data. The application image data is image data to be displayed which will be explained in the present embodiment. The application image data includes various types of object data. Note that information indicating the type of the object to be described below may be included in the application image data or may be obtained through analysis of the application image data.

The RAM 111 functions as a main memory and a work area of the CPU 105, an area for a video image to be displayed on the LCD 101, and a storage area of the application image data.

The display controller (DISPC) 108 switches the output of the video image developed in the RAM 111 in a high speed and also outputs a synchronous signal to the LCD 101, in response to a request of the CPU 105. As a result, the video image of the RAM 111 is output to the LCD 101 in synchronization with the synchronous signal of the DISPC 108, and an image is displayed on the LCD 101.

In response to a request of the CPU 105, the panel controller (PANELC) 109 controls the touch panel 102 and the button device 103. By this control, the CPU 105 is notified of a touch position on the touch panel 102 (by close approach or contact of an indicator such as a finger or a stylus pen onto the touch panel 102), a pushed-down key code of the button device 103, or the like. The touch position is expressed by a coordinate indicating an absolute position in the horizontal direction of the touch panel 102 (hereinafter, “X coordinate”) and a coordinate indicating an absolute position in the vertical direction (hereinafter, “Y coordinate”). The touch panel 102 can detect touch operation at plural positions and, in this case, the CPU 105 is notified of touch position information sets in the number of touch input positions.

The wireless LAN module 106, according to the control of the CPU 105, establishes wireless communication with a wireless LAN module on a wireless access point (not shown in the drawing) connected to a LAN and intermediates communication with the mobile information terminal 100. The wireless LAN module 106 includes a type of IEEE802.11b or the like, for example.

The power source controller 107 is connected to an external power source (not shown in the drawing) and receives power supply. Thereby, the power source controller 107 charges the secondary battery 112 connected thereto and also supplies power to the entire mobile information terminal 100. In the case where the power is not supplied from the external power source through the power source controller 107, the secondary battery 112 supplies the power to the entire mobile information terminal 100.

The timer 113 generates a timer interrupt to a gesture event generation unit 201 to be described below, according to the control of the CPU 105.

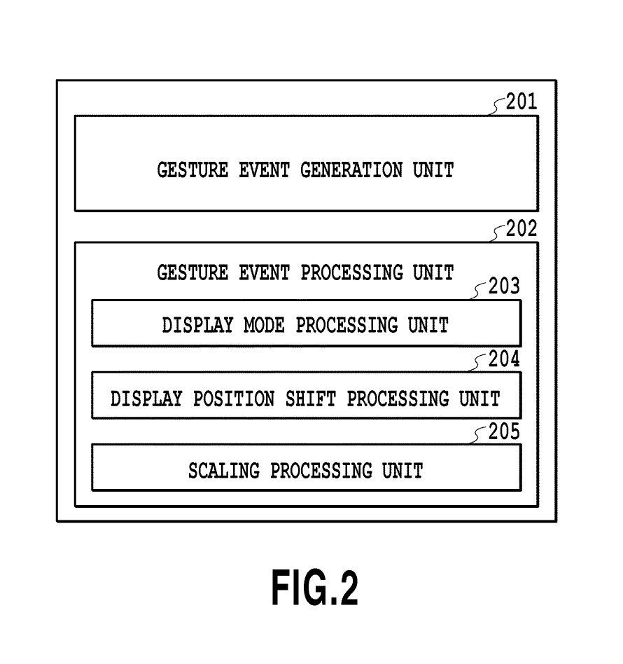

Next, the application program executed by the CPU 105 of the mobile information terminal 100 will be explained. FIG. 2 is a block diagram showing a configuration concept of the application program executed by the CPU 105.

The CPU 105 can read the application program from the ROM 110, and can store it in the RAM 111 and execute it. Each part included in the application program to be shown in the following is realized by a combination of the following components; that is, the CPU 105, a region in the RAM 111 for storing the application program, and a region in the RAM 111 for storing information which the CPU 105 obtains by executing the application program (calculation result and the like), for example.

The gesture event generation unit 201 receives a touch input from the touch panel 102 via the panel controller 109 and generates various types of gesture event to be described below. The gesture event generation unit 201 transmits the generated gesture event to a gesture event processing unit 202.

The gesture event processing unit 202 receives the gesture event generated by the gesture event generation unit 201 and carries out processing depending on each of the gesture events and the application image data. The gesture event processing unit 202 includes a display mode processing unit 203, a display position shift processing unit 204, and a scaling processing unit 205.

The display mode processing unit 203 performs switching of a display mode and selection of an object to be displayed, in the case where the application image data is displayed on the touch UI 104.

The display position shift processing unit 204 performs processing for swipe operation performed by a user onto the touch panel 102.

The scaling processing unit 205 performs processing for pinch-in operation and pinch-out operation performed by the user onto the touch panel 102. The scaling processing unit 205 scales and updates display contents on the touch UI 104 according to the pinch-in operation or the pinch-out operation.

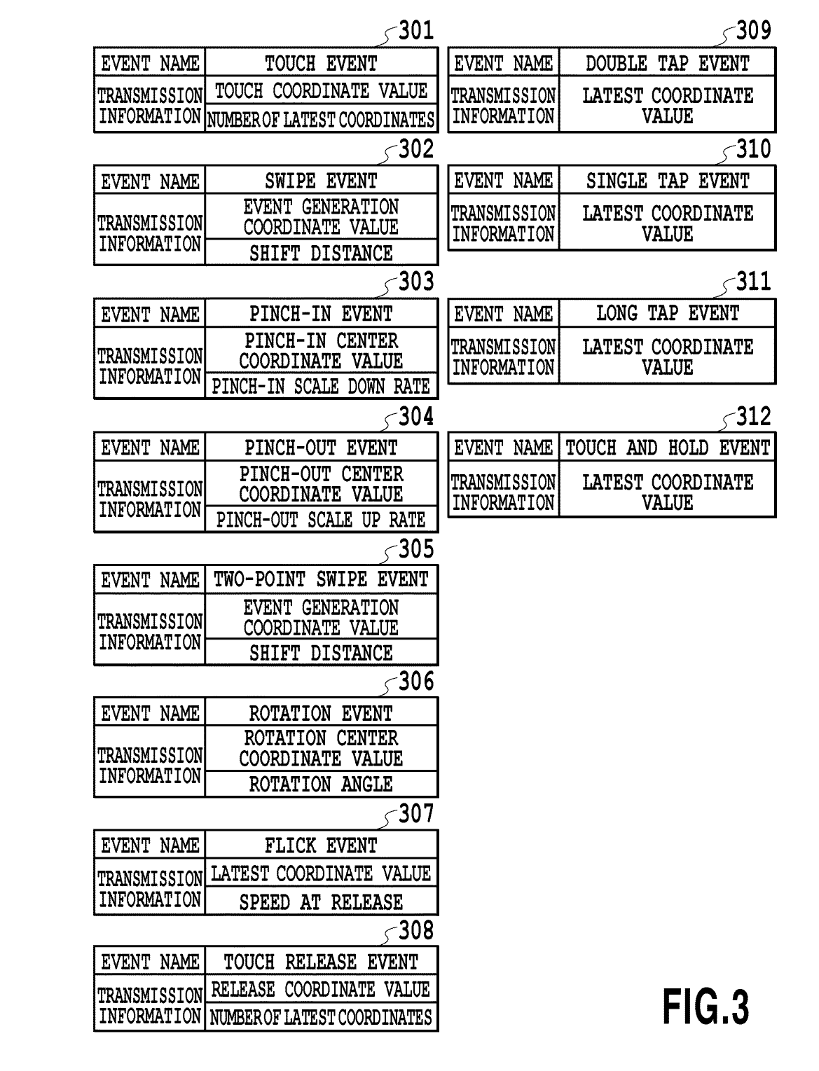

Next, by the use of FIG. 3, the gesture event generated by the gesture event generation unit 201 will be explained. FIG. 3 is a conceptual diagram showing a gesture event name and information to be transmitted to the gesture event processing unit 202 in the case where each of the events is generated.

Reference numeral 301 indicates a touch event, and the gesture event generation unit 201 transmits the coordinate values of a touch input position and the number of touch coordinates on the touch panel 102. The touch coordinate has a pair of coordinate values which are expressed by an X coordinate and a Y coordinate indicating the latest touch point. Further, the number of touch coordinates indicates the number of touch positions. Note that the interrupt is generated from the timer 113 and the touch coordinate is updated in cases where a user's finger contacts the touch panel 102, the finger is shifted, and the finger is released.

Reference numeral 302 indicates a swipe event, and the gesture event generation unit 201 transmits the coordinate values of the latest touch coordinate and a shift distance calculated from differences between the latest coordinate values and the last coordinate values. Here, “swipe” means an operation in which a fingertip is shifted (as slid) in one direction while being caused to touch the touch panel 102.

Reference numeral 303 indicates a pinch-in event, and the gesture event generation unit 201 transmits the center coordinate values of the touch coordinates for the latest two points and a pinch-in scale-down rate calculated from a scale-down distance in a straight line connecting the touch coordinates of two points. Here, “pinch-in” means an operation in which two fingertips are caused to come close to each other (as pinching) while being in contact with the touch panel 102.

Reference numeral 304 indicates a pinch-out event, and the gesture event generation unit 201 transmits the center coordinate values of the touch coordinates for the latest two points and a pinch-out scale-up rate calculated from an scale-up distance in a straight line connecting the touch coordinates of the two points. Here, “pinch-out” means an operation in which two fingertips are separated from each other (as fingers are opened) while being in contact with the touch panel 102.

Reference numeral 305 indicates a two-point swipe event, and the gesture event generation unit 201 transmits the coordinate values of the touch coordinates for the latest two points and shift distances calculated from differences between the latest coordinate values and the last coordinate values of the touch coordinates for the two points. The two point swipe event is generated in the case where the touch coordinates of the two points are shifted in the same direction.

Reference numeral 306 indicates a rotation event, and the gesture event generation unit 201 transmits the center coordinate value of rotation calculated from the coordinate values of the touch coordinates for the latest two points and a rotation angle calculated from the latest coordinate values and the last coordinate values of the touch coordinates for the two points. Here, “rotation” means an operation in which two fingertips are rotated with respect to the touch panel 102 while being in contact with the touch panel 102.

Reference numeral 307 indicates a flick event, and the gesture event generation unit 201 transmits the coordinate values of the latest touch coordinate and shift speed of a finger which is calculated from the latest coordinate values and the last coordinate values. Here, “flick” means an operation in which a finger is released while being swiped (as flicking with a finger).

Reference numeral 308 indicates a touch release event, and the gesture event generation unit 201 transmits the coordinate values of the latest touch coordinate at the timing that a user' s finger is released from the touch panel 102, and the number of coordinates.

Reference numeral 309 indicates a double tap event, and the gesture event generation unit 201 transmits the coordinate values of the latest touch coordinate. Here, an operation in which a finger is brought into touch with the touch panel 102 and an operation in which the finger is released in a predetermined time since this touch operation, are performed as a pair of operations (single tap event to be described below), and “double tap” means an operation in which this pair of operations is performed two times consecutively in a predetermined time.

Reference numeral 310 indicates a single tap event, and the gesture event generation unit 201 transmits the coordinate values of the latest touch coordinate. Here, as described above, “single tap” means an operation in which a finger is released in a predetermined time since an operation of bringing the finger into touch with the touch panel 102.

Reference numeral 311 indicates a long tap event, and the gesture event generation unit 201 transmits the coordinate values of the latest touch coordinate. Here, “long tap” means an operation in which a finger is released from the touch panel after a predetermined time or more has elapsed since an operation of bringing the finger into touch with the touch panel 102.

Reference numeral 312 indicates a touch and hold event, and the gesture event generation unit 201 transmits the coordinate values of the latest touch coordinate. Here, “touch and hold event” means an operation in which a user' finger is not shifted at all for a predetermined time or more since the finger has touched the touch panel 102.

Note that, while the case of using a finger is shown here as an example of the user's touch input, the touch input may be performed by input using a stylus pen or the like.

Now, from here, there will be explained how the contents of the application image data is displayed on the touch UI 104.

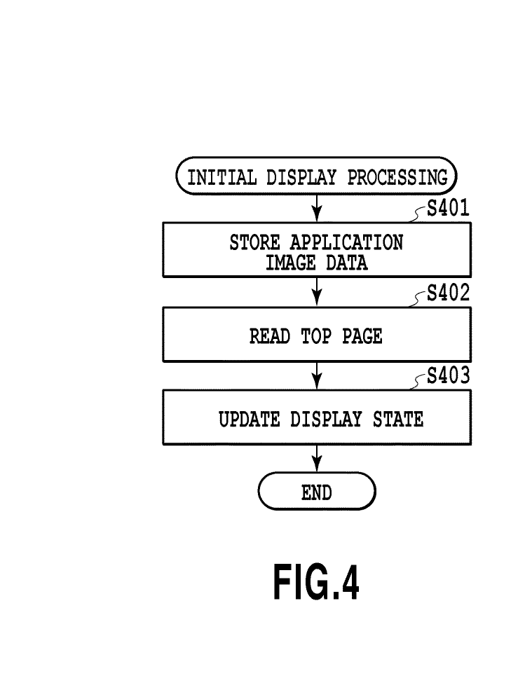

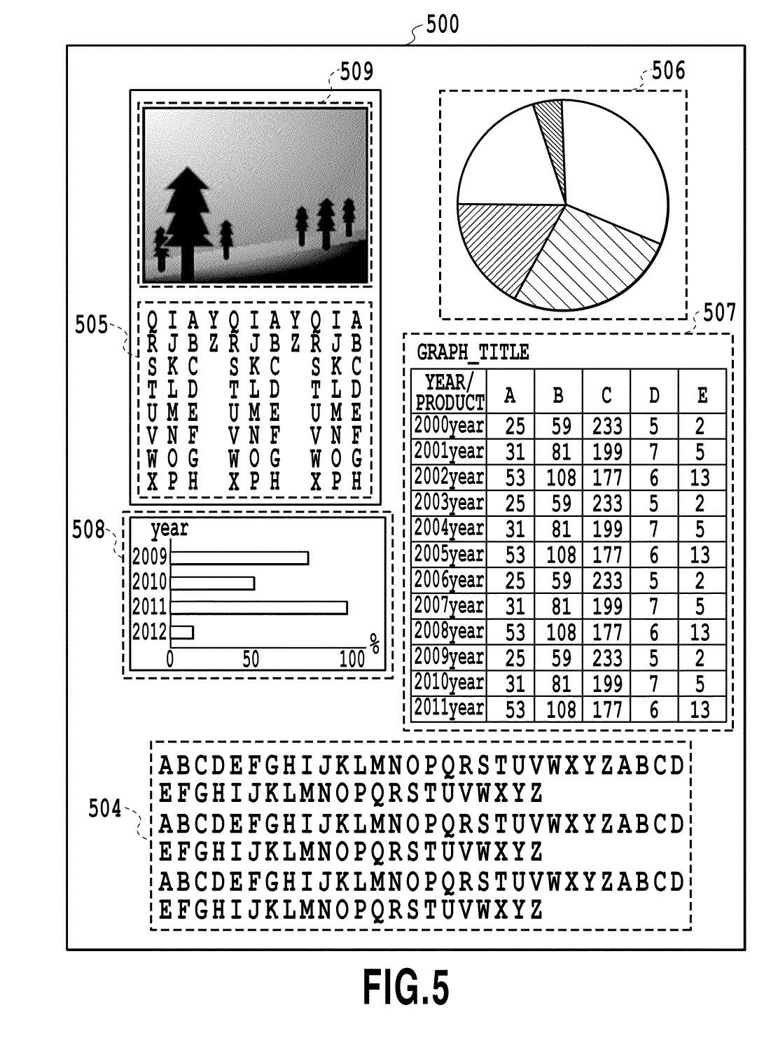

By the use of FIG. 4 and FIG. 5, there will be explained initial display processing for the contents of the application image data. FIG. 4 is a flowchart showing a procedure of the initial display processing for the contents of the application image data. This flowchart is realized by the CPU 105 executing the application program as the display mode processing unit 203. The display mode processing unit 203 receives the application image data from another device in the outside (here, MFP) via the wireless LAN module 106 and then starts the present processing.

First, in step S401, the display mode processing unit 203 stores the received application image data in the RAM 111.

Next, in step S402, the display mode processing unit 203 reads a top page and an object included therein in the application image data stored in the RAM 111.

In step S403, the display mode processing unit 203 generates display image data for all the objects of a character, a photograph, and a graphic included in the read top page according to a start point coordinate, width, and height of the object. Then, the display mode processing unit 203 writes the display image data into the video image area of the RAM 111 and causes the touch UI 104 to update display contents via the display controller 108. Note that, in the following explanation, the above processing from the display image data generation to the display content update in the touch UI 104 is sometimes described simply as processing of “causing the touch panel 102 to update the display contents”.

FIG. 5 is a screen view showing a display example of the touch UI 104 of the mobile information terminal 100. After the display mode processing unit 203 has finished carrying out step S403, the contents of the top page is displayed on the touch UI 104 as shown in FIG. 5. At this time, the display mode processing unit 203 determines a display magnification of the top page according to the width of the touch UI 104. In the case where the height of the page scaled to the display magnification is smaller than that of the touch UI 104, the display mode processing unit 203 determines a start point of the page 500 at a coordinate on the touch UI 104 so as to display the page in the center of the touch UI 104. Further, in the case where the height of the page 500 scaled to the display magnification is larger than that of the touch UI 104, the start point of the page 500 is determined at coordinates on the touch UI 104 so as to match the start point of the touch UI 104 (e.g., upper left of the screen).

Here, by the use of FIG. 5, each of the objects included in the page 500 will be explained.

Object 504 is a character attribute object having a horizontal text direction.

Object 505 is a character attribute object having a vertical text direction.

Object 506 is a graphic attribute object.

Object 507 is a table object having headers in the top row and the top column.

Object 508 is a bar graph of a graphic attribute object.

Object 509 is a photograph attribute object.

Here, a broken line surrounding each of the objects in FIG. 5 is drawn for easiness of explanation and does not exist actually on the page 500.

In the above, it has been explained how the contents of the application image data is displayed on the touch UI 104. From here, there will be explained how the display position is shifted according to the swipe operation for the display contents. Note that, while processing according to the swipe operation will be explained in the following, the present embodiment is not limited to the case of the swipe operation. The present embodiment may be applied for any of the above described operation modes as far as the operation mode provides a display position shift instruction as the flick operation, for example. In the present embodiment, control of suppressing display position shift is performed for an image corresponding to the object displayed on the touch UI 104 depending on the attribute of the object.

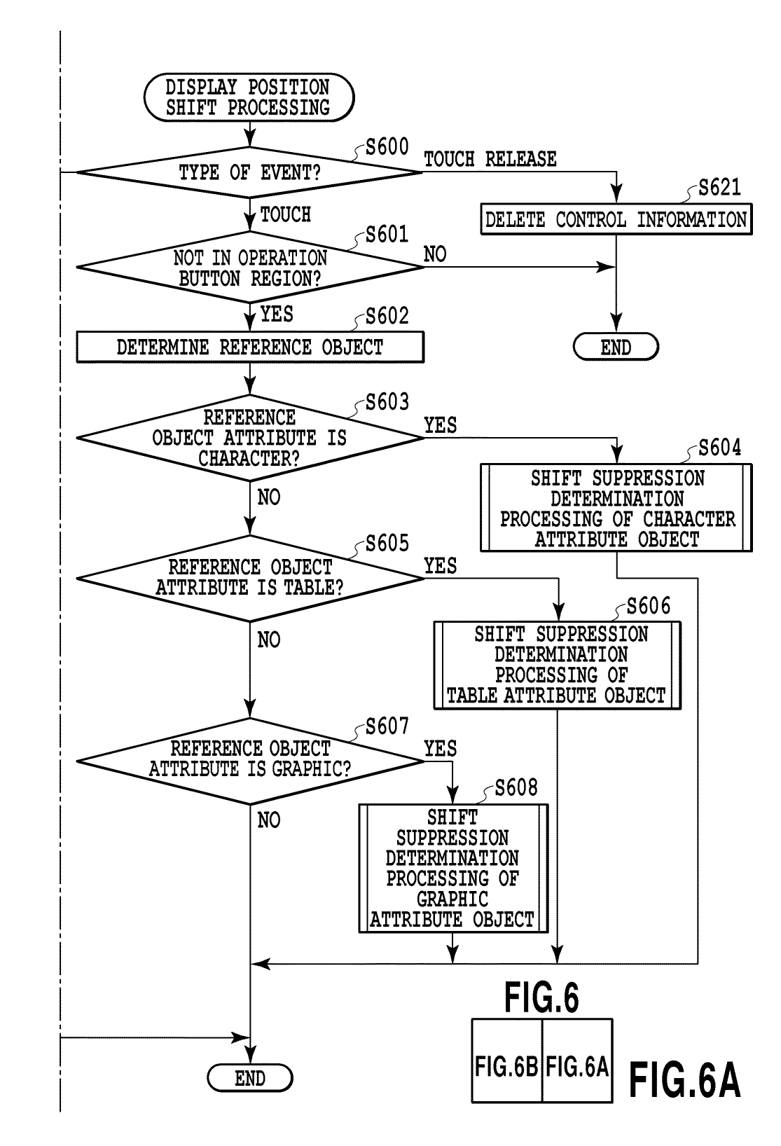

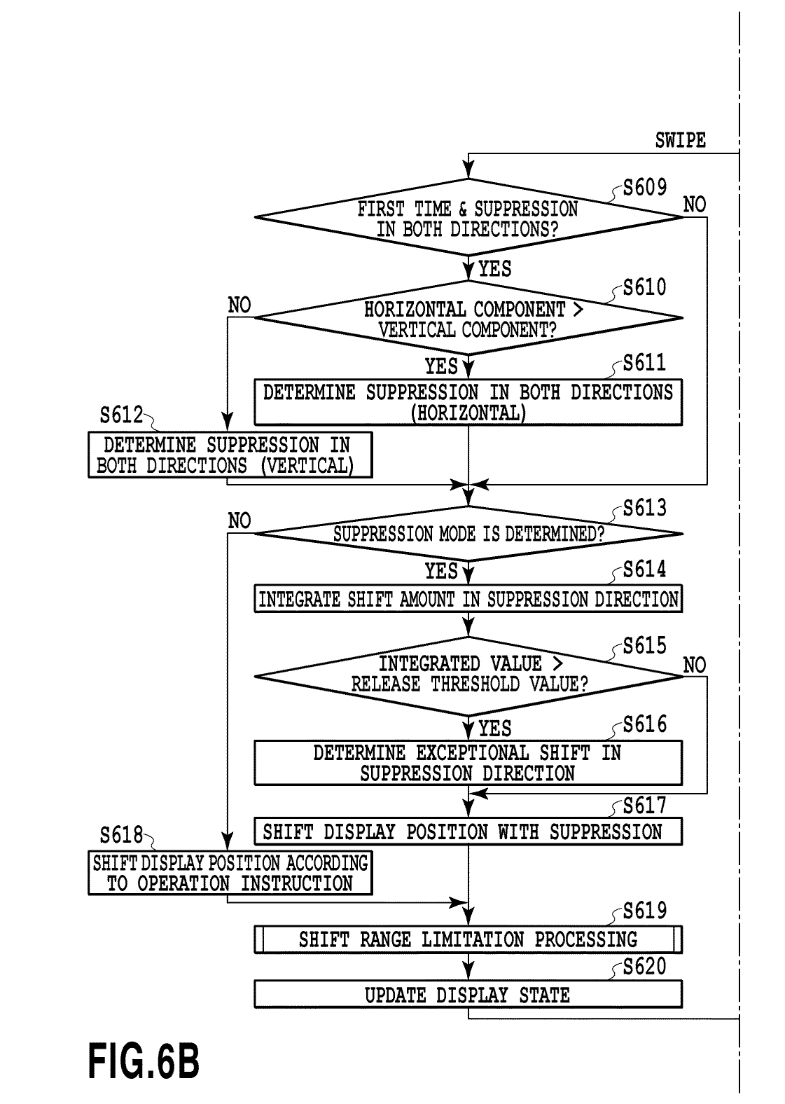

Next, by the use of FIGS. 6A and 6B, there will be explained display position shift processing in the present embodiment. FIGS. 6A and 6B indicate a flowchart showing a procedure of the display position shift processing in the present embodiment. This flowchart is realized by the CPU 105 executing the application program as a display position shift processing unit 204. The display position shift processing unit 204 detects the touch operation, the swipe operation, and the touch release operation via the touch UI 104, and starts the present processing.

First, in step S600, the display position shift processing unit 204 determines the type of the event. For starting the swipe operation, a user touches the touch UI 104 first. Thereby, the gesture event generation unit 201 generates the touch event and notifies the gesture event processing unit 202 of the event. Accordingly, in step S600, the display position shift processing unit 204 determines that the event is the touch event in this case and transits to step S601. The display position shift processing unit performs the processing of step S601 and the following steps as will be described below. After having touched, the user slides a finger while touching the touch UI 104. Thereby, the gesture event generation unit 201 generates the swipe event and notifies the gesture event processing unit 202 of the event. Accordingly, in step 600, the display position shift processing unit 204 determines that the event is the swipe event in this case and transits to step S609. The display position shift processing unit 204 performs processing of step 5609 and the following steps as will be described below. Lastly, the user releases the finger from the touch UI 104 for finishing the swipe operation. Thereby, the gesture event generation unit 201 generates the touch release event and notifies the gesture event processing unit 202 of the event. Accordingly, in step S600, the display position shift processing unit 204 determines that the event is the touch release event in this case and transits to step S621.

First, the processing will be explained from the case that the event is determined to be the touch event in step S600.

In step S601, the display position shift processing unit 204 determines whether or not the touch operation is performed in an operation button region such as a mode switching button, a next button, and a previous button, from the coordinate values of a touch input position in the touch event. In the case where the coordinate values of the touch input position is not included in the operation button region, it is determined that the touch operation is not performed for the operation button and the process transits to step S602. In the case determined otherwise, that is, in the case where it is determined that the coordinate values of the touch input position is included in the operation button region, the process is terminated.

In step S602, the display position shift processing unit 204 determines a reference object. Here, the reference object is an object which is included in a currently read page and used as a reference for determining a suppression mode of the display position shift. The display position shift processing unit 204 determines the reference object as follows. For example, an area ratio of each object in a region which is included in the page and displayed on the touch UI 104 is calculated and the object having the largest area ratio (having the largest size) can be determined as the reference object. Alternatively, an object having a rectangular block which includes the upper left end point of the region displayed on the touch UI 104 and the rectangular center point of the region maybe determined as the reference object. Further, an object having a rectangular block including the touch position of the touch operation carried out by the user in advance of the swipe operation may be determined as the reference object. While the reference object can be determined as described above, the method described first (determination by the area ratio of each object in the display region) will be employed in the present embodiment.

In step S603, the display position shift processing unit 204 determines whether the attribute of the reference object determined in step S602 is the character attribute or not. For the case determined to be the character attribute, the process transits to step S604 and, for the case determined otherwise, the process transits to step S605. Information indicating the object attribute is included in the application image data. Alternatively, the display position shift processing unit 204 may determine the object attribute by analyzing the application image data. As an analysis method of the object attribute, it is possible to apply a publicly known technique. For example, image data is divided into rectangular blocks each having a predetermined size, and the object attribute can be specified according to the size or shape of the rectangular block. An object of a rectangular block which has an aspect ratio close to one and a size in a certain range, for example, can be specified as the character object. Further, an object of a flat pixel block or an object of a black pixel block which includes well-arranged white pixel blocks each having a square shape of a certain size or larger can be specified as a graphic object. Further, among the graphic objects, an object including the character attribute in a certain range can be specified as a table object.

In step S604, the display position shift processing unit 204 carries out shift suppression determination processing of the character attribute object. This is processing of determining a suppression mode of the display position shift with reference to the character attribute object. Details will be described below.

In step S605, the display position shift processing unit 204 determines whether the attribute of the reference object determined in step S602 is a table attribute or not. For the case determined to be the table attribute, the process transits to step S606, and, for the case determined otherwise, the process transits to step S607.

In step S606, the display position shift processing unit 204 carries out shift suppression determination processing of the table attribute object. This is processing of determining a suppression mode of the display position shift with reference to the table attribute object. Details will be described below.

In step S607, the display position shift processing unit 204 determines whether the attribute of the reference object determined in step S602 is a graphic attribute or not. For the case determined to be the graphic attribute, the process transits to step S608, and, for the case determined otherwise, the process is terminated. That is, for the case determined to be an attribute other than the character attribute, the graphic attribute, and the table attribute, the process is terminated.

In step S608, the display position shift processing unit 204 carries out shift suppression determination processing of the graphic attribute object. This is processing of determining a suppression mode of the display position shift with reference to the graphic attribute object. Details will be described below.

Here, in each of step S604, step S606, and step S608, the suppression mode of the display position shift can be determined as any of the following modes.

1. Suppression only in the horizontal direction: The display position shift is suppressed only in the horizontal direction.

2. Suppression only in the vertical direction: The display position shift is suppressed only in the vertical direction.

3. Suppression in both directions: The display position shift is suppressed in both of the horizontal direction and the vertical direction, and it is determined in step S610 to be described below in which direction the suppression is carried out.

The display position shift processing unit 204 stores the determined suppression mode of the display position shift into the RAM 111 for management.

Next, the processing will be explained for the case determined to be the swipe event in step S600.

In step S609, the display position shift processing unit 204 determines whether or not the swipe event is received first after the reception of the touch event and the suppression mode of the display position shift is determined to be the suppression in both directions. For the case determined to be “YES”, the process transits to step S610, and for the case determined otherwise, the process transits to step S613.

For the case determined that the swipe event is received first and also the suppression mode of the display position shift is determined to be the suppression in both directions, in step S610, the display position shift processing unit 204 analyzes a shift amount included in the received swipe event. That is, the display position shift processing unit 204 vector-decomposes the shift amount to obtain a horizontal direction component and a vertical direction component, using positions of the latest and last touch coordinates which are included in the received swipe event. Then, the both direction components are compared. In the case where the horizontal direction component is determined to be larger, the process transits to step S611, and in the case determined otherwise, the process transits to step S612.

In step S611, the display position shift processing unit 204 determines that the suppression mode of the display position shift is the suppression in both directions and the display position shift is suppressed in the vertical direction for this swipe operation. On the other side, in step S612, it is determined that the suppression mode of the display position shift is the suppression in both directions and the display position shift is suppressed in the horizontal direction for this swipe operation. Then, the determined suppression directions are stored in the RAM 111 for management.

In the reception of the second swipe event and the following swipe events, the determination in step S609 is “NO” and step S610 to step S612 are not carried out. However, the display position shift is controlled with reference to the suppression directions which are stored in the RAM 111 as the results of the step S610 to step S612 which have been carried out previously. Here, in the case where the suppression is determined to be carried out only in the horizontal direction or only in the vertical direction in each of step S604, step S606, and step S608, the determined suppression mode is stored in the RAM 111 in each of the steps. Thereby, in the case where the swipe event is the first one and the suppression mode is not the suppression in both directions, and in the case where the second swipe event and the following swipe events are received, the display position shift is controlled with reference to the suppression directions stored in this RAM. This is processing in next step S613.

In step S613, the display position shift processing unit 204 determines whether the suppression mode is determined or not in the processing so far. This determination is performed by confirming whether the determined suppression mode is recorded in the RAM 111. For the case of the determination that the suppression mode has been determined, the display position shift processing unit 204 transits to step S614, and, for the case of the determination that the suppression mode has not been determined, the display position shift processing unit 204 transits to step S618.

In step S614, the display position shift processing unit 204 calculates an integrated value of the components in the direction in which the display position shift is suppressed, for the shift amounts included in the swipe event. The shift amount included in the swipe event can be vector-discomposed into a component in the horizontal direction (X-axis direction) and a component in the vertical direction (Y-axis direction) from the latest touch position coordinates and the last touch position coordinates included in the swipe event. Out of the components in both directions obtained by the vector decomposition, a value of the component in the suppression direction is added every time the swipe event arrives and the result is stored into the RAM 111.

Then, in step S615, the display position shift processing unit 204 compares the integrated value calculated in step S614 with a predetermined threshold value (release threshold value). This release threshold value may be determined to be a value which is not like an input error by a user but a value capable of determining probably an shift instruction in the suppression direction, such as a value of one third of the width in the display region of the touch UI 104 in the horizontal direction or the vertical direction, for example. In the case where the integrated value of the shift amount in the suppression direction is determined to be larger than the release threshold value, the process transits to step S616, and, for the case determined to be smaller, the process transits to step S617.

In step S616, the display position shift processing unit 204 determines that the display position is shifted in the suppression direction by an amount of the integrated value calculated in step S613. In the present embodiment, the display position shift is suppressed depending on the object attribute, and thus it is not possible to shift the display position in the suppression direction. Accordingly, in the case where the user provides an instruction of the shift exceeding the release threshold value in the suppression direction, the shift is exceptionally permitted to be performed in the suppression direction. By step S614, step S615, and step S616, the exceptional shift in the suppression direction is realized. Further, in step S616, the display position shift processing unit 204 initializes the integrated value of the shift amount in the suppression direction to zero.

In step S617, the display position shift processing unit 204 shifts the start point of the page depending on the suppression mode and shifts the display position. In more detail, the following processing is performed. The shift amount included in the swipe event is vector-decomposed into the component in the horizontal direction and the component in the vertical direction using the position of the latest touch coordinate and the position of the last touch coordinate included in the swipe event. Then, the component in the suppression direction is corrected to zero. Alternatively, in the case where the shift is determined to be performed also in the suppression direction in step S616 according to the integrated value calculated in step S614, the integrated value is added to the component in the suppression direction. The X coordinate and the Y coordinate of the page start point are shifted according to the above obtained vector.

In the case where the suppression mode is determined not to be determined in step S613, in step S618, the display position shift processing unit 204 shifts the page start point and shifts the display position, according to the contents of the swipe event.

In step S619, the display position shift processing unit 204 carries out shift range limitation processing. This is processing of correcting the display position appropriately for the case of a partial region display mode. Details of the partial region display mode and the shift range limitation processing will be described below.

Lastly, in step S620, the display position shift processing unit 204 updates the display contents of the touch UI 104 according to the page start point determined in the above processing.

On the other side, in the case where the event is determined to be the touch release event in step S600, the following processing is performed.

In step S621, the display position shift processing unit 204 deletes the information about the suppression mode of the display position shift stored in the RAM 111. Specifically, the display position shift processing unit 204 deletes the information stored in the RAM 111 in step S604, step S606, step S608, step S611, and step S612. Further, the display position shift processing unit 204 deletes also the integrated value of the shift amount in the suppression direction which is calculated in step S614 and stored in the RAM 111.

Note that, in the present embodiment, in the case where a user touches the touch UI 104 and performs the swipe operation, the mobile information terminal 100 can display a scroll bar of the horizontal direction at the lower edge of the screen and a scroll bar of the vertical direction at the right edge of the screen. In this case, it is possible to change a display mode of the scroll bars at the right and left edges of the screen depending on the suppression direction of the display position shift which is determined in this processing. Note that the scroll bars may be displayed at the upper edge and the left edge of the screen. In the present embodiment, the scroll bar corresponding to the suppression direction is drawn by the use of semi-transparent color having a high transparency and the scroll bar corresponding to the non-suppression direction is drawn by the use of an opaque color, for example. In step S620, it is also possible to cause the touch UI 104 to update the display contents so as to display the scroll bars as described above. Note that, the method of controlling the display mode on the touch UI 104 depending on the suppression direction of the display position shift is not limited to the method of this example and another method may be used.

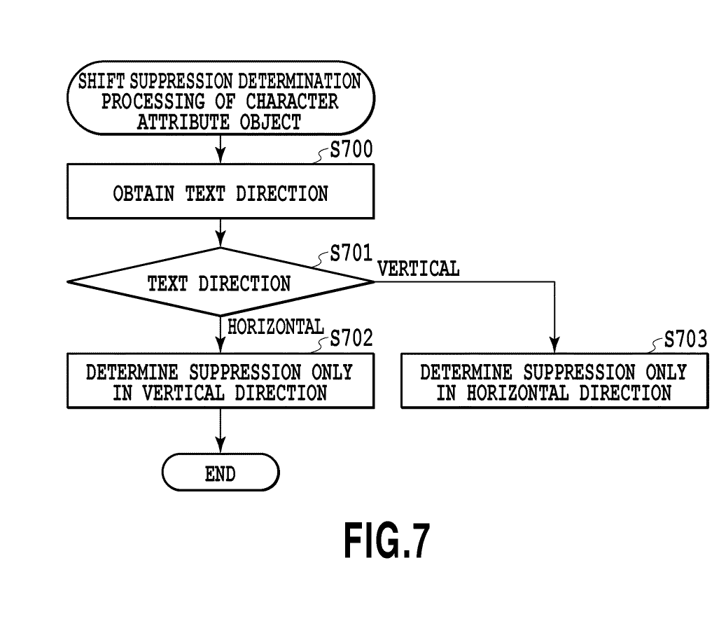

Next, by the use of FIG. 7, the shift suppression determination processing of the character attribute object in the present embodiment, which is shown in step S604 of FIG. 6A, will be explained. FIG. 7 is a flowchart showing a procedure of the shift suppression determination processing of the character attribute object. This flowchart is realized by the CPU 105 executing the application program as the display position shift processing unit 204.

In step S700, the display position shift processing unit 204 obtains the text direction of the character attribute object. The text direction is included in the application image data. Further, the text direction may be obtained by means of analyzing the application image data. For example, the horizontal and vertical projections of a pixel value are obtained in a specific region of a character attribute object. Then, the dispersions of the projections are evaluated. The text direction can be obtained to be horizontal in the case where the dispersion of the horizontal projection is larger, and to be vertical in the case where the dispersion of the vertical projection is larger.

In step S701, the display position shift processing unit 204 determines the text direction, and transits to step S702 in the case where the text direction is determined to be horizontal, and transits to step S703 in the case where the text direction is determined to be vertical.

In step S702, the display position shift processing unit 204 determines that the suppression mode of the display position shift is the suppression only in the vertical direction. This is because, since the object to be processed in this processing is characters in horizontal writing, the display position is configured to be shifted in the horizontal direction which is the text direction and not to be shifted in the vertical direction.

On the other side, in step S703, the display position shift processing unit 204 determines that the suppression mode of the display position shift is the suppression only in the horizontal direction. In this case, since the object to be processed in this processing is characters in vertical writing, the display position is configured to be shifted in the vertical direction which is the text direction, and not to be shifted in the horizontal direction.

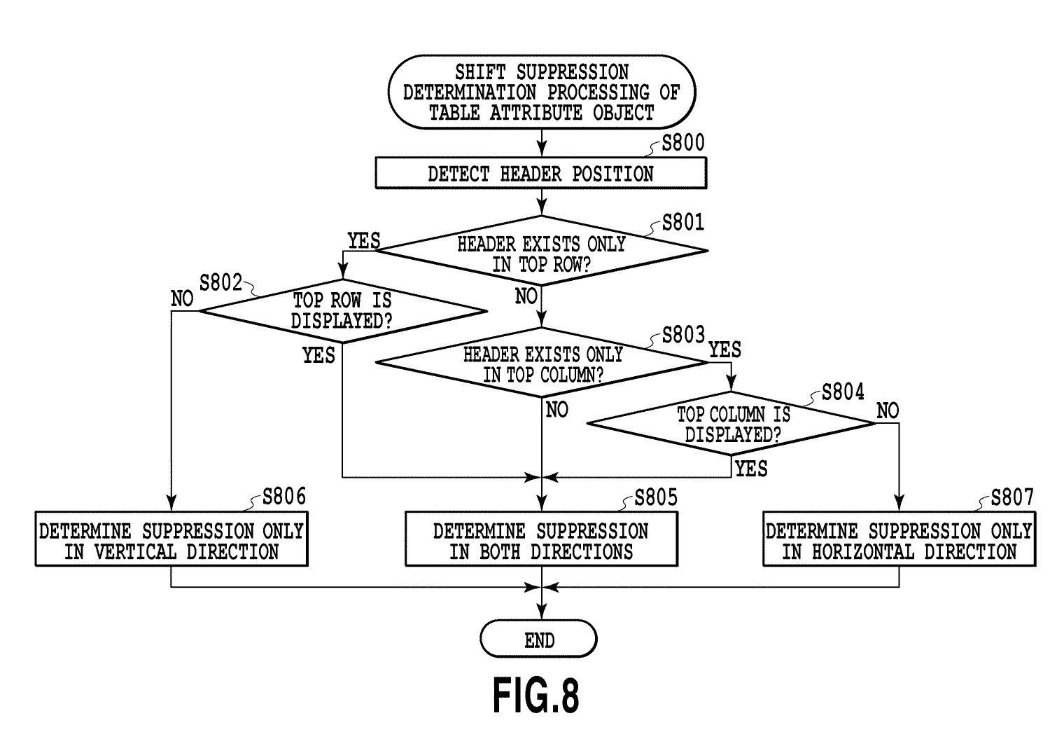

Next, by the use of FIG. 8, the shift suppression determination processing of the table attribute object in the present embodiment, which is shown in step S606 of FIG. 6A, will be explained. FIG. 8 is a flowchart showing a procedure of the shift suppression determination processing of the table attribute object. This flowchart is realized by the CPU 105 executing the application program as the display position shift processing unit 204.

In step S800, the display position shift processing unit 204 detects a header position. The header position can be detected by whether the type of a character font is bold or not in the top row (highest row) or the top column (most left column), the width of an approximated curve line for vector data in vector conversion, the width of a table ruled line, the background color of each cell in a table, or the like, for example.

In step S801, the display position shift processing unit 204 determines whether the header exists only in the top row or not. In the case where the header exist only in the top row, the process transits to step S802, and, for the case determined otherwise, the process transits to step S803.

In step S802, the display position shift processing unit 204 determines whether or not the top row including the header is displayed on the touch UI 104. For example, the display position shift processing unit 204 determines whether or not the top row including the header is displayed on the touch UI 104, by using the start point of a current page and the positions of a rectangular block region of the table attribute object to be processed and the top row in this region. In the case where the top row including the header is determined not to be displayed, that is, in the case where the header exists only in the top row but this top row is not displayed, the process transits to step S806 and the suppression mode is determined to be the suppression only in the vertical direction as in the step S702 shown in FIG. 7. This is because, in the case where the header exists only in the top row, operation that the contents of the header in the top row is confirmed first and then reading is proceeded along the row is presumed for referring to the table object. That is, the display position is configured to be shifted along the row direction (horizontal direction) and not to be shifted in the vertical direction. On the other side, in step S802, for the case that the top row is determined to be displayed, the process transits to step S805.

In step S803, the display position shift processing unit 204 determines whether or not the header exists only in the top column. In the case where the header exists only in the top column, the process transits to step S804, and, for the case determined otherwise, the process transits to step S805.

In step S804, the display position shift processing unit 204 determines whether or not the top column including the header is displayed on the touch UI 104 by using the start point of the current page and the position of the rectangular block region of the table attribute object to be processed and the top column in this region. In the case where the top column including the header is determined not to be displayed, that is, in the case where the header exists only in the top column but this top column is not displayed, the process transits to step S807 and the suppression mode is determined to be the suppression only in the horizontal direction as in the step S703 shown in FIG. 7. This is because, in the case where the header exists only in the top column, operation that the contents of the header in the top column is confirmed first and then reading is proceeded along the column is presumed for referring to the table object. That is, the display position is configured to be shifted along the column direction (vertical direction) and not to be shifted in the horizontal direction. On the other side, in step S804, for the case that the top column is determined to be displayed, the process transits to step S805.

In step S805, the display position shift processing unit 204 determines that the suppression mode of the display position shift is the suppression in both directions. In the case where each of the top row and the top column includes the header, or in the case where neither the top row nor the top column include the header, it is presumed that the display position is shifted either along the row or along the column by the swipe operation. For the display position shift direction indicated by the swipe operation, the display position shift processing unit 204 compares the components in the horizontal direction and the vertical direction (step S611) and shifts the display position only in the direction having a larger component so as not to cause a shift in the direction perpendicular to a direction intended by the user. Further, in the present flowchart, the processing of step S805 is carried out also for the following case, that is, the case that the header exists only in the top row and also the header is displayed on the touch UI 104, and the case that the header exists only in the top column and also the header is displayed on the touch UI 104. In the case where the header exists only in the top row, the display position is shifted along the row as described above, but, in the case where the header in the top row is displayed, it is presumed that the display position is shifted in the vertical direction and the contents of the header are referred to sequentially. Therefore, also in the case where the header exists only in the top row, the display position is configured to be shifted along the row direction or the column direction, for the case that the header is displayed. This is the same for the case that the header exists only in the top column.

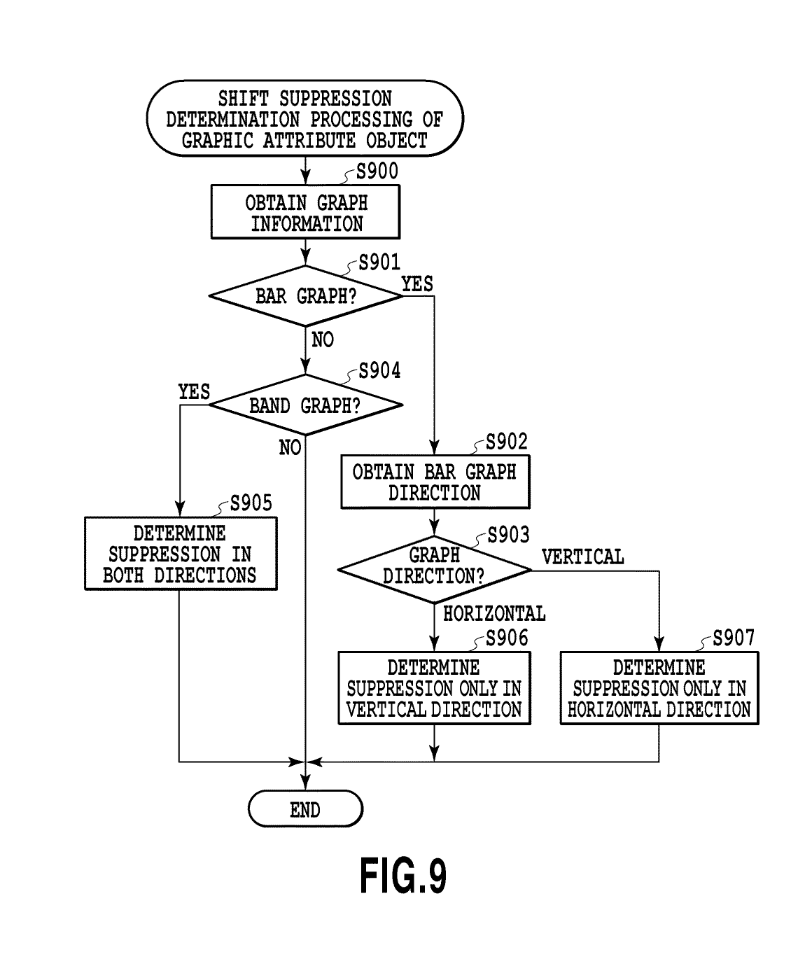

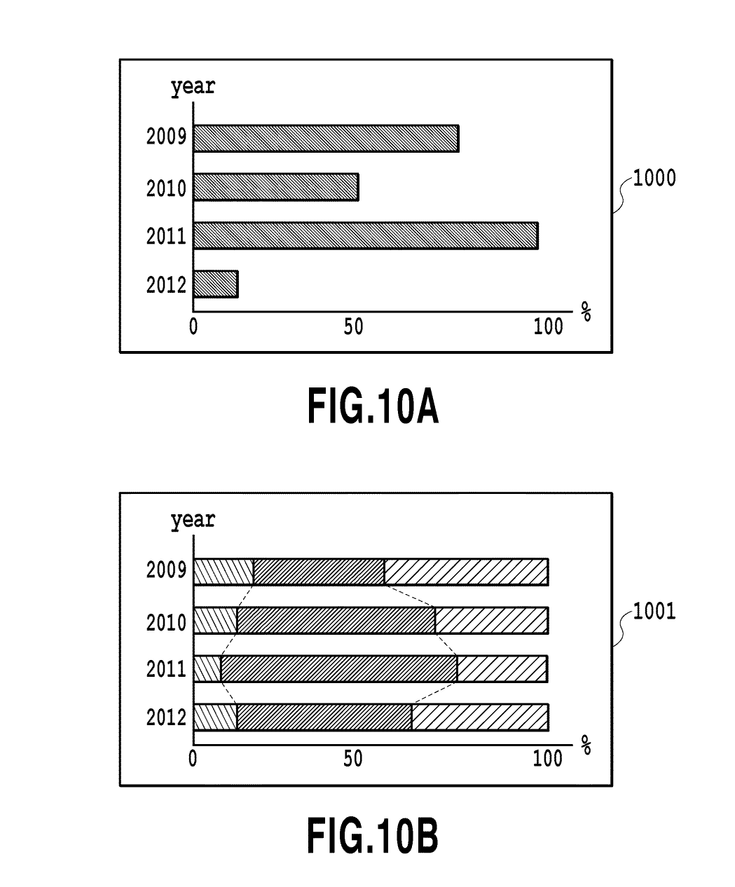

Next, by the use of FIG. 9, FIG. 10A, and FIG. 10B, the shift suppression determination processing of the graphic attribute object in the present embodiment, which is shown in step S608 of FIG. 6A, will be explained. FIG. 9 is a flowchart showing a procedure of the shift suppression determination processing of the graphic attribute object. This flowchart is realized by the CPU 105 executing the application program as the display position shift processing unit 204. Further, FIG. 10A is a diagram showing an example of a bar graph as the graphic attribute object to be processed in the present processing. FIG. 10B is a diagram showing an example of a band graph as the graphic attribute object to be processed in the present processing.

First, in step S900, the display position shift processing unit 204 obtains graph information. The graph information is information indicating the type of a graph, and included in the application image data. Alternatively, the display position shift processing unit 204 may obtain the graph information generated by analyzing the application image data. For example, the graph information can be obtained by vector conversion of the object using a publicly known method.

In step S901, the display position shift processing unit 204 determines whether the graphic attribute object to be processed in the present processing is a bar graph or not. In the case where the graph information is obtained in step S900 and also the information indicates the bar graph, the process transits to step S902, and, for the other case, the process transits to step S904.

In step S902, the display position shift processing unit 204 obtains the direction of the bar graph. The graph direction is included in the graph information. Alternatively, the direction of the bar graph can be determined also by the shape of a graph bar or the position of an axis. For example, in a case of a bar graph 1000 of FIG. 10A, the total sum of the widths of the graph bars in the horizontal direction is larger than the total sum of the widths in the vertical direction. Further, the vertical axis exists at the left edge part of the graph. In the case where such a bar graph is referred to on the touch UI 104 having a small display region, it is presumed that labels on side of the vertical axis are confirmed and then the graph is referred to while the display position is shifted along the graph bar in the horizontal direction by swipe operation. Accordingly, the direction of the bar graph can be determined to be horizontal in this case. The display position shift processing unit 204 obtains the graph direction in this manner in step S902.

In step S903, the display position shift processing unit 204 determines the graph direction obtained in step S902. In the case where the graph direction is determined to be horizontal, the process transits to step S906, and the suppression mode is determined to be the suppression only in the vertical direction as in the case of step S702 shown in FIG. 7. On the other side, in the case where the graph direction is determined to be vertical, the process transits to step S907, and the suppression mode is determined to be the suppression only in the horizontal direction as in the case of step S703 shown in FIG. 7.

In step S904, the display position shift processing unit 204 determines whether the graphic attribute object to be processed in the present processing is a band graph or not. In the case where the graph information is obtained in step S900 and also the graph information indicates the band graph, the suppression mode is determined to be the suppression in both directions as in the case of step S805 shown in FIG. 8. For example, as shown in a band graph 1001 of FIG. 10B, in the band graph, sometimes composition ratios in graph bars are connected by a dotted line between the graph bars, and it is presumed that the user refers to the graph while comparing graph bars with one another. Accordingly, in the case of the band graph, supposedly, the display position is shifted along the graph direction as in the case of the bar graph or the display position is shifted along the axis direction. Therefore, the suppression mode is determined to be the suppression in both directions, and the suppression direction is determined by the determination in the first swipe event (S611).

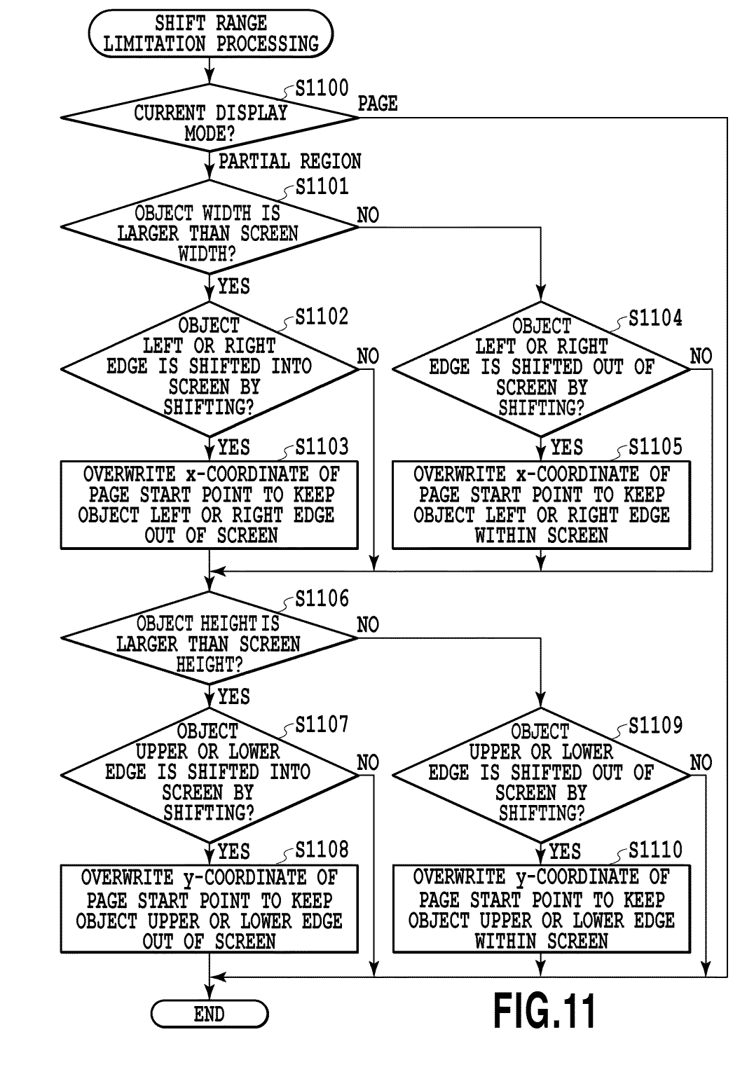

Next, by the use of FIG. 11, the shift range limitation processing which is shown in step S619 of FIG. 6B will be explained. The shift range limitation processing is processing of correcting the display position appropriately in the case of the partial region display mode. FIG. 11 is a flowchart showing a procedure of the shift range limitation processing. This flowchart is realized by the CPU 105 executing the application program as the display position shift processing unit 204.

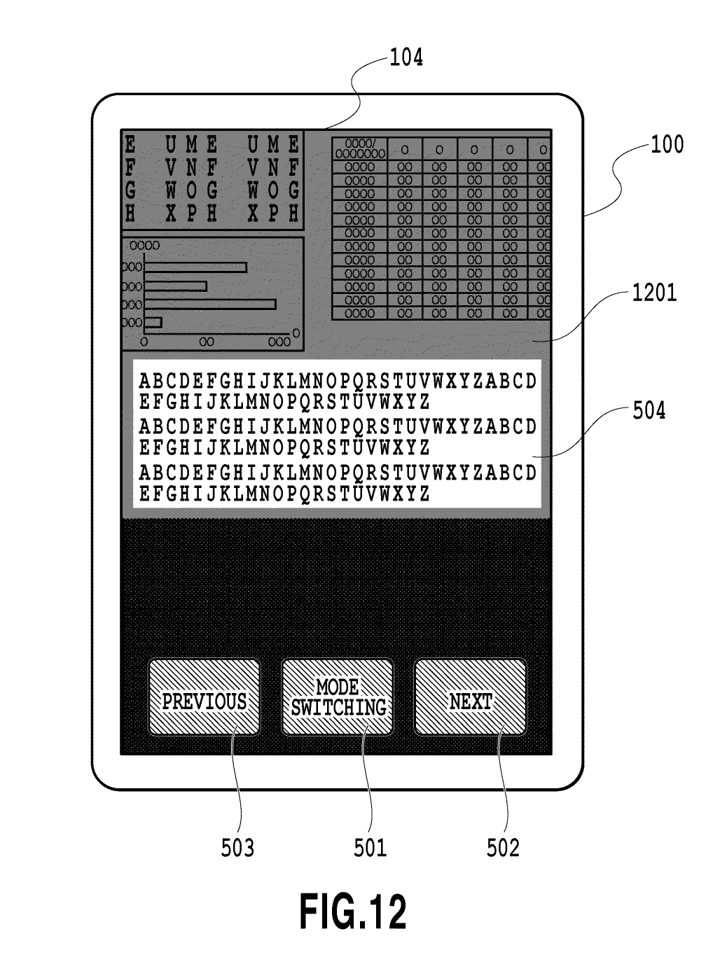

First, the partial display mode will be explained by the use of FIG. 5 and FIG. 12. The mobile information terminal 100 can include two display modes; a page display mode suitable for displaying the whole page as shown in FIG. 5 and the partial region display mode suitable for expanding and displaying each of the objects in the page as shown in FIG. 12. In the present embodiment, immediately after the mobile information terminal 100 has received the application image data, the page display mode is set. The partial region display mode is a display mode in which the display magnification and the start point of the page 500 is controlled so as to cause each of the objects in the page 500 to be displayed in an expanded size as shown in FIG. 12. FIG. 12 shows a screen displayed in the case where the object 504 is selected as an object to be displayed in an expanded size. Further, in the present embodiment, a semi-transparent mask 1201 is displayed overlapping with the contents of the page 500 such that a region except the object to be displayed in an expanded size (here, object 504) is displayed in semi-transparent gray as shown in FIG. 12. By the display of such a semi-transparent mask in overlapping, the part except the object to be displayed is displayed darkly and therefore the object to be displayed is displayed emphatically and the user can easily recognize the object to be displayed.

Further, in FIG. 12, the mode switching button 501 is a button for switching the display mode between the page display mode and the “partial region display mode”. The display mode processing unit 203 carries out mode switching processing in response to an instruction to the mode switching button 501.

The next button 502 is a button for switching a currently displayed object and displaying the next object in the partial region display mode. The display mode processing unit 203 selects the next object in response to an instruction to the next button 502.

The previous button 503 is a button for switching a currently displayed object and displaying a previous object in the partial region display mode. The display mode processing unit 203 selects the previous object in response to an instruction to the previous button 503.

Note that, the display mode processing unit 203 can perform control so that it is impossible to instruct the next button 502 and the previous button 503, in the case where the display mode is the page display mode.

In FIG. 11, processing of appropriately correcting the display position will be explained in the case of using such a partial region display mode.

In step S1100, the display position shift processing unit 204 obtains a current display mode and determines whether the display mode is the partial region display mode or not. In the case where the display mode is the partial region display mode, the process proceeds to step S1101 and, in the case of the page display mode, the process is terminated without performing any processing.

In step S1101, the display position shift processing unit 204 determines whether or not the width of an object which is read currently and displayed in a current page display magnification is larger than the screen width of the touch UI 104. At this time, in the case where the width of the object is larger than the screen width of the touch UI, the process proceeds to step S1102, and, for the other case, the process proceeds to step S1104.

In step S1102, the display position shift processing unit 204 determines whether or not the left edge or the right edge of the object is shifted into the screen of the touch UI 104. As a result, in the case where the left edge or the right edge of the object is determined to be shifted into the screen of the touch UI, the process proceeds to step S1103, and, for the other case, the process proceeds to step S1106.

In step S1103, the display position shift processing unit 204 corrects the X coordinate of the page start point, and shifts and returns the left edge or the right edge of the object shifted into the screen to the screen edge of the touch UI 104. This is performed for making the region where the object is displayed, as large as possible, also in the case where the object width exceeds the screen width of the touch UI.

Further, in step S1104, the display position shift processing unit 204 determines whether or not the left edge or the right edge of the object is shifted out of the screen of the touch UI 104. As a result, in the case where the left edge or the right edge of the object is determined to be out of the screen of the touch UI 104, the process proceeds to step S1105, and, for the other case, the process proceeds to step S1106.

In step S1105, the display position shift processing unit 204 corrects the X coordinate of the page start point, and shifts and returns the left edge or the right edge of the object to the edge of the screen. This is performed for the purpose that the width of the object is included in the screen width of the touch UI and the whole object is displayed.

In step S1106, the display position shift processing unit 204 determines whether or not the height of the object, which is currently read and displayed in the current page display magnification, is larger than the screen height of the touch UI104. At this time, in the case where the height of the object is larger than the screen height of the touch UI, the process proceeds to step S1108, and, for the other case, the process proceeds to step S1109.

In step S1107, the display position shift processing unit 204 determines whether or not the upper edge or the lower edge of the object is shifted into the screen of the touch UI 104, in the case where the display position of the page including the object is shifted according to a shift distance of a swipe event. As a result, in the case where the upper edge or the lower edge of the object is determined to be within the screen of the touch UI, the process proceeds to step S1108, and, for the other case, the process in terminated.

In step S1108, the display position shift processing unit 204 corrects the Y coordinate of the page start point, and shifts and returns the upper edge or the lower edge of the object, which is shifted into the screen, to the edge of the screen such that the object is displayed as much as possible.

In step S1109, the display position shift processing unit 204 determines whether or not the upper edge or the lower edge of the object is shifted out of the screen in the touch UI. In the case where the upper edge or the lower edge of the object is determined to be shifted out of the screen in the touch UI, the process proceeds to step S1110, and, for the other case, the process is terminated.

In step S1110, the display position shift processing unit 204 corrects the Y coordinate of the page start position, and shifts and returns the upper edge or the lower edge of the object into the screen such that the whole object is displayed.

In this manner, by limiting the shift range of the object, the user can recognize the edge part of the object easily.

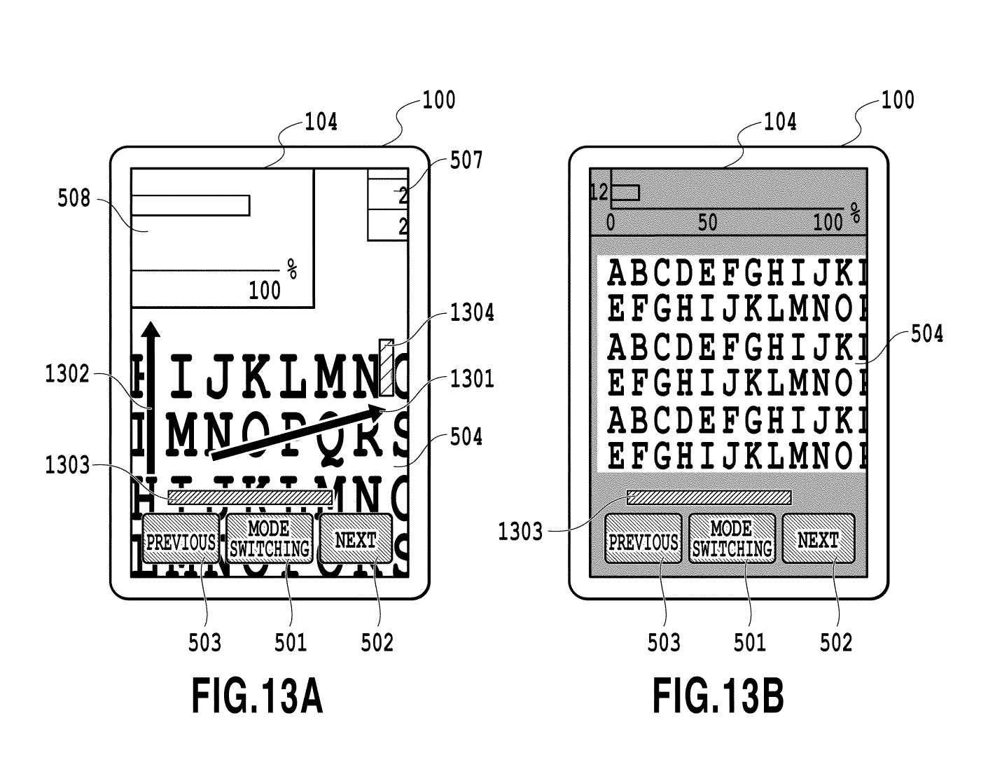

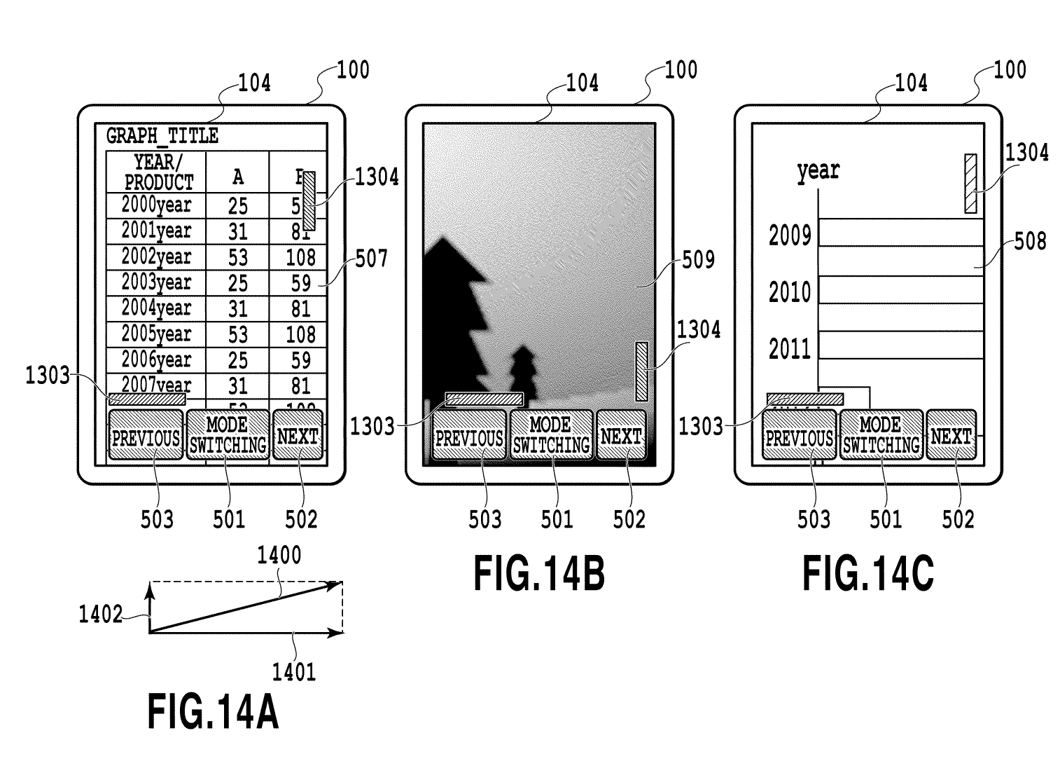

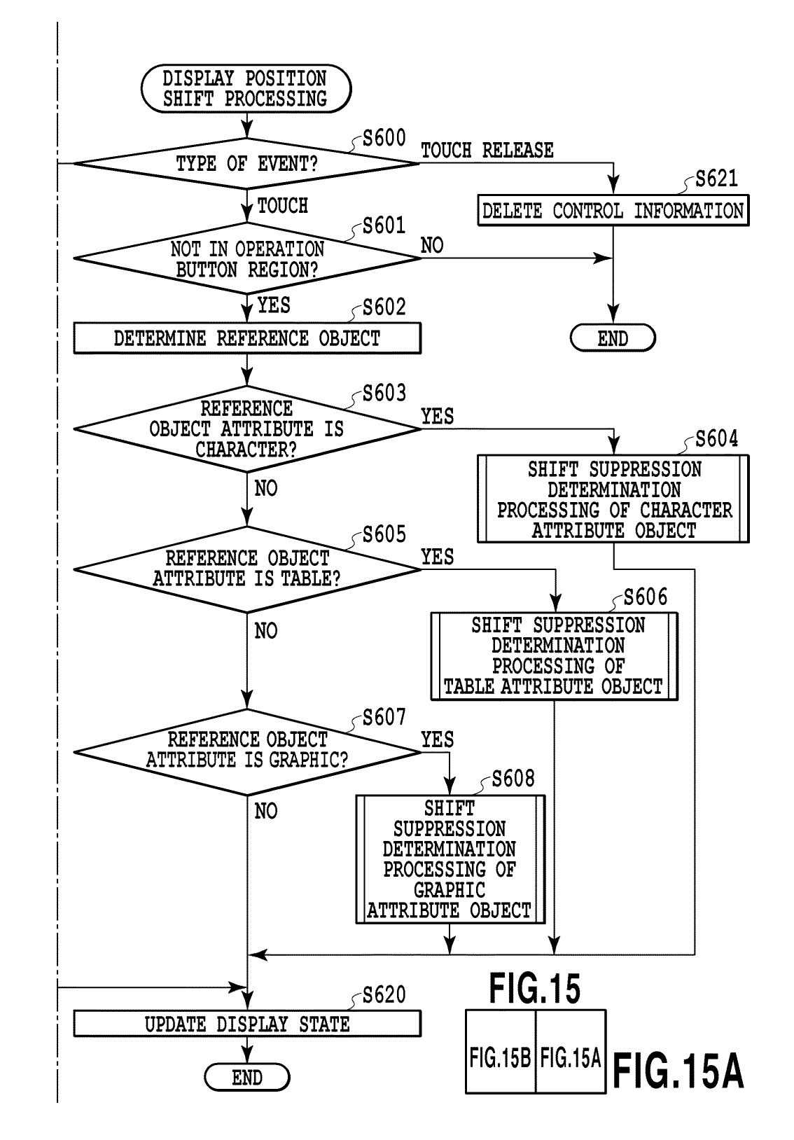

Next, by the use of FIG. 13 and FIG. 14A to FIG. 14C, the display contents on the touch UI 104, which are displayed by the shift processing of the display position, will be explained. FIG. 13A, FIG. 13B, and FIG. 14A to FIG. 14C are screen views showing display examples on the touch UI 104 in the mobile information terminal 100.

FIG. 13A shows a screen in the case where the display of the page 500 shown in FIG. 5 in the page display mode is expanded and displayed. The scale-up display can be performed by the pinch-out operation. Further, FIG. 13B shows a screen in the case where the object 504 shown in FIG. 5 is expanded and displayed in the partial region display mode. While FIG. 13A shows the object 504, the object 507, and the object 508, as shown in the drawing, the area ratio is the largest in the object 504. Further, FIG. 13B expands and displays the object 504 in the partial region display mode. That is, in both of FIG. 13A and FIG. 13B, the reference object determined in step S602 in FIG. 6A is the object 504. Then, the object 504 has the character attribute of the horizontal text direction. Therefore, in the case where the user performs the swipe operation on the touch UI 104 which displays these screens, the mobile information terminal 100 suppresses the display position shift in the vertical direction and performs the display position shift only in the horizontal direction. For example, the user is assumed to start reading on the object 504, which has the character attribute of the horizontal writing, along the text direction by the swipe operation. At this time, even in the case where the user unintentionally performs the swipe operation having a trajectory schematically shown by the arrow 1301 (finger is slid from the start point to the endpoint while touching the screen), the display position is not shifted in the vertical direction and shifted only in the horizontal direction. Note that, in the case where the swipe operation is performed having a vertical component of a shift amount exceeding the release threshold value as shown by the arrow 1302, the shift instruction is determined to be performed intentionally in the vertical direction and the display position is shifted also in the vertical direction by the shift amount. On the other side, in the case where the reference object is the character attribute object having the vertical text direction as the object 505, for the swipe operation shown by the arrow 1301, the display position shift is suppressed in the horizontal direction and performed only in the vertical direction. Note that, the arrows 1301 and 1302 only express the trajectories of the swipe operation and are not displayed on the screen.

Here, in FIG. 13A, reference numeral 1303 indicates the scroll bar of the horizontal direction, and reference numeral 1304 indicates the scroll bar of the vertical direction. In the case of FIG. 13A, since the display region shift is suppressed in the vertical direction, the mobile information terminal 100 displays the vertical direction scroll bar 1304 in a color having a higher transparency than that of the horizontal direction scroll bar 1303. This suggests that the display position shift is suppressed in the vertical direction.

Further, while, in the partial region display mode of FIG. 13B, the drawing shows an example that the horizontal direction scroll bar 1303 is displayed and the vertical direction scroll bar is not displayed, the vertical direction scroll bar may be displayed.

Further, FIG. 14A shows a screen in the case where the object 507 shown in FIG. 5 is expanded and displayed in the partial region display mode. Here, the following explanation is the same also for the case of the scale-up display in the page display mode. The object 507 has the table attribute, and also has the headers in the top row and the top column as shown in the drawing. Accordingly, in the case where the user performs the swipe operation on the touch UI 104 which displays the screen of FIG. 14A, the shift is suppressed in either one of the directions, depending on the magnitude relationship in the horizontal component and the vertical component of a thereby caused shift amount in the first swipe event. Then, the display position is shifted only in the other direction. As an example, in the case where the first swipe operation is expressed by the arrow 1400, the horizontal component is larger as shown in the drawing, in the comparison of the horizontal component (arrow 1401) and the vertical component (arrow 1402). Accordingly, in this case, the display position is shifted only in the horizontal direction according to a shift amount of the horizontal component. For example, in the case where the user focuses on a certain row header and is going to read on values of the columns in this row, even for the case that the user performs the swipe operation unintentionally as shown by the arrow 1400, the display position is not shifted in the vertical direction. Note that, in the case where the user focuses on a certain column header and is going to read on values of the rows in this column, the user may perform the swipe operation in which the vertical component is larger than the horizontal component. Thereby, the shift is suppressed in the horizontal direction and the display position can be shifted only in the vertical direction. Further, in the case where the user performs the touch release operation, the suppression is released in the vertical direction or the horizontal direction, and the suppression mode is determined again depending on the first swipe event of the next swipe operation. Therefore, the user can perform the operation each time, changing a viewing manner such as reading-on in the row direction and reading-on in the column direction.

Further, in the case where the reference object is a table attribute object without including the row header or the column header, the mobile information terminal 100 suppresses the display position shift as in the case of the object 507.

In the case where the reference object is a table attribute object having only the row header, the mobile information terminal 100 suppresses the display position shift in the vertical direction and performs the display position shift only in the horizontal direction, as in the case of the object 504. Note that, in the case where the row header is displayed in the display region of the touch UI 104, the mobile information terminal 100 suppresses the display position shift as in the case of the object 507.

In the case where the reference object is a table attribute object having only the column header, the mobile information terminal 100 suppresses the display position shift in the horizontal direction and performs the display position shift in the vertical direction as in the case of the object 505. Note that, in the case where the column header is displayed in the display region of the touch UI 104, the mobile information terminal 100 suppresses the display position shift as in the case of the object 507.

FIG. 14B shows a screen in the case where the object 509 shown in FIG. 5 is expanded and displayed in the partial region display mode. Here, the following explanation is the same also for the case of the scale-up display in the page display mode. Since the object 509 is a photograph attribute object, the suppression is not performed in any direction, even in the case where the user performs any swipe operation on the touch UI 104 which displays the screen shown in FIG. 14B. The user can display a desired portion of a photograph by the swipe operation. At this time, the mobile information terminal 100 does not carry out unnecessary suppression of the shift direction.

Note that, in the case of FIG. 14A, at the step that the user touches the touch UI 104, it is not determined in which direction the display position shift is suppressed. Accordingly, as shown in the drawing, both of the horizontal direction scroll bar 1303 and the vertical direction scroll bar 1304 may be displayed in a color having a low transparency (opaque color). At the timing that the user starts the swipe operation by sliding a finger from the touch state, the mobile information terminal 100 suppresses the display region shift in either the horizontal direction or the vertical direction according to the first swipe event. At this time, the scroll bar of the corresponding shift direction is displayed in a color having a high transparency as in the vertical direction scroll bar 1304 in FIG. 13A. Further, in FIG. 14B, since the display region shift is not suppressed in any direction, the horizontal direction scroll bar 1303 and the vertical direction scroll bar 1304 are always displayed in a color having a low transparency (opaque color).

FIG. 14C shows a screen in the case where the object 508 shown in FIG. 5 is scale-up and displayed in the partial region display mode. The following explanation is the same also in the case of the scale-up display in the page display mode. The object 509 is an object having the graphic attribute and also an object of a bar graph. Then, the graph direction thereof is the horizontal direction. Accordingly, in the case where the user performs the swipe operation on the touch UI 104 which displays the screen of FIG. 14C, the mobile information terminal 100 suppresses the display position shift as in the case of the object 504. In the case where the reference object is a graphic attribute object of a bar graph having a graph direction in the vertical direction, the display position shift is suppressed as in the case of the object 505. In the case where the reference object is a band graph, the display position shift is suppressed as in the case of the object 507.

As described above, according to the present embodiment, the display position shift can be suppressed depending on the attribute of the object to be displayed. Since the display position shift in which the features of the object is reflected can be provided, it is possible to browse a document appropriately even in a display apparatus having a small screen such as a mobile terminal.

Note that, while the present embodiment shows the example that the swipe operation is terminated by the reception of the touch release event, the swipe operation may be terminated after a certain time has elapsed since the reception of the touch release event by the use of the timer 113. After a certain time has elapsed, step S621 can be carried out. Further, within a certain time, the swipe operation can be continued after the touch event has been received again. In the case where the display position shift direction is suppressed, the suppression is released after a certain time has elapsed. Alternatively, without reception of the touch release event, step S621 may be carried out in the case where the swipe operation is not performed for a certain time (the swipe event is not received or, although the swipe event is received, the shift amount is very small and smaller than a predetermined threshold value). Then, these certain times may be determined depending on the reference object attribute.

Further, the release threshold value may be determined depending on the reference object attribute.

Moreover, as a condition for suppressing the display position in the horizontal (vertical) direction, the following condition may be considered; the condition that a certain or larger ratio is obtained in the case where the rectangular block size of the reference object in the horizontal (vertical) direction is compared with the display region size of the touch UI 104 in the horizontal (vertical) direction. That is, in the case where the maximum display position shift is not so large, the suppression of the shift direction is configured not to be performed.

Further, in the present embodiment, for the case of the suppression in both directions, it is determined whether the suppression is performed in the horizontal direction or in the vertical direction, by the determination of the first swipe event after the reception of the touch event. However, the determination may be performed not by the first swipe event but by initial several swipe events, and the horizontal components or the vertical components of the several swipe events are added and the magnitude of the integrated value may be compared.

### Embodiment 2

Embodiment 1 shows the example that the display position shift is suppressed depending on the attribute of the object to be displayed (reference object) in the case where the swipe operation is performed. However, in the case where the user is unable to move a finger precisely in the horizontal direction or the vertical direction in the initial motion of the swipe operation, there is a possibility that an unintentional operation is caused. The present embodiment shows an example that the display position shift suppression is performed depending on the attribute of the object to be displayed under the condition that a specific operation is performed. This is particularly useful in a use scene in which the display apparatus is not held firmly. As the specific operation, there will be explained an example of the swipe operation in the true horizontal direction or the true vertical direction, in an error range within a threshold value.

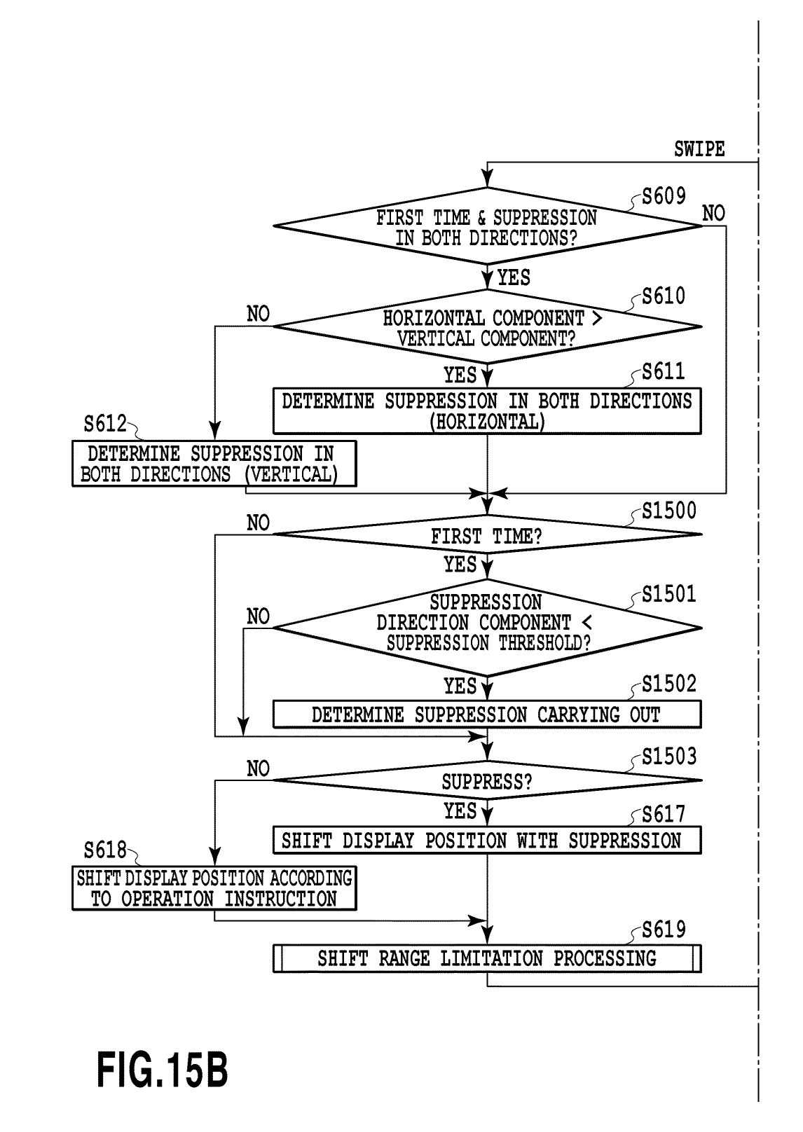

By the use of FIGS. 15A and 15B, display position shift processing in the present embodiment will be explained. FIGS. 15A and 15B indicate a flowchart showing a procedure of the display position shift processing in the present embodiment. This flowchart is realized by the CPU 105 executing the application program as the display position shift processing unit 204. The display position shift processing unit 204 detects the touch operation, swipe operation, and the touch release operation via the touch UI 104 and starts the present processing.

Since the present processing has many similar points in the processing contents, compared with the processing shown in FIGS. 6A and 6B of Embodiment 1, only step S1500 to step S1503 will be explained here as a different point.

In step S1500, the display position shift processing unit 204 determines whether the received event is the first swipe event or not. In the case where the received event is determined to be the first swipe event, the process transits to step S1501, and, for the other case, the process transits to step S1503.

In step S1501, the display position shift processing unit 204 vector-discomposes the shift amount included in the received swipe event into the horizontal direction and vertical direction components using the coordinate positions of the latest and last touch coordinates included in the same swipe event. Then, the display position shift processing unit 204 determines whether or not the component of the suppression direction is within a predetermined threshold value (suppression threshold value). This suppression threshold value may be determined to be a value such as one fifth of the width of the display region on the touch UI 104 in the horizontal direction or the vertical direction, for example. In the case where the user performs the swipe operation intentionally in the horizontal direction or the vertical direction, preferably the value easily absorbs an input error caused nevertheless in the vertical direction for the horizontal direction swipe operation or in the horizontal direction for the vertical direction swipe operation. In the case where the component in the suppression direction is smaller than the suppression threshold value, the process transits to step S1502, and, for the other case, the process transits to step S1503.

In step S1502, the display position shift processing unit 204 determines that the suppression of the display position shift is to be performed. Then, the determination that the suppression is determined to be performed is stored in the RAM 111 for management. By the determination in step S1501, it is understood that the user is going to shift the display position intentionally in the true horizontal direction or in the true vertical direction. From this understanding, the display position shift is determined to be suppressed.

In step S1503, the display position shift processing unit 204 determines whether the display position shift is to be performed or not. This is performed depending on whether or not the RAM 111 stores the determination that the suppression is to be performed in step S1502. In the case where the suppression is determined to be performed, the processing shown in step S617 of FIG. 6B is carried out. That is, the page start point is shifted and the display position is shifted depending on the suppression mode. For the other case, the processing shown in step S618 of FIG. 6B is carried out. That is, depending on the contents of the swipe event, the page start point is shifted and the display position is shifted.

As described above, according to the present embodiment, under the condition that the specific operation is performed, the display position shift can be suppressed depending on the attribute of the object to be displayed. According to Embodiment 2, it is possible to reduce the inconvenience that the suppression is carried out in an unnecessary case.

Note that the “specific operation” may be dealt with by another method such as a method of displaying an operation button and detecting an instruction to the operation button, for example, other than the method shown in the present embodiment.

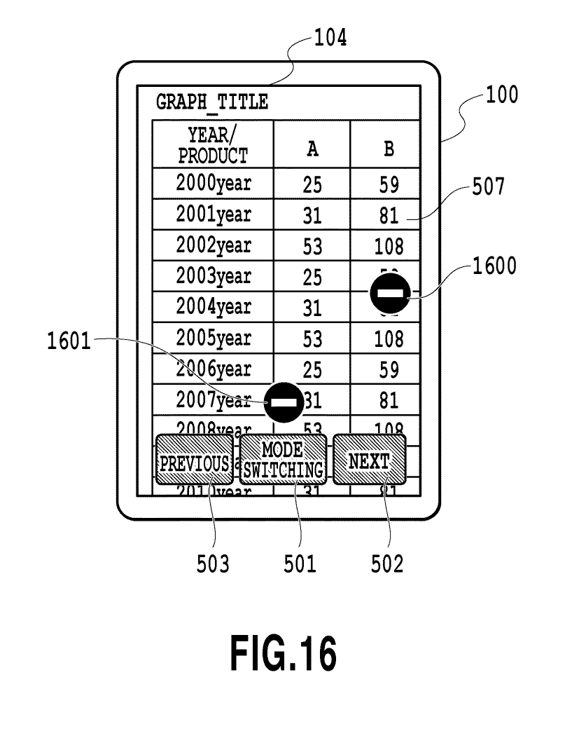

Further, the determination in which direction the suppression of the display position shift can be carried out depending on the reference object, may be configured as can be shown to the user. For example, in the case where the display position shift processing unit 204 receives the double tap event, the display position shift processing unit 204 determines the reference object and carries out step S604, step S606, and step S608. Thereby, the display on the touch UI 104 is updated depending on a determined suppression mode of the display position shift. For example, as shown in FIG. 16, in the case where the suppression of the display position shift is carried out in the horizontal direction, a mark 1600 is displayed. In the case where the suppression of the display position shift is carried out in the vertical direction, a mark 1601 is displayed. Note that, while each of the mark 1600 and the mark 1601 shows an example of a display component which indicates the shift suppression direction to the user by a display position thereof, an icon (display component) may be provided for the mark itself indicating the shift suppression direction.

Further, in the present embodiment, in step S1500, the display position shift processing unit 204 determines the first swipe event after the reception of the touch event and determines whether the suppression is to be carried out or not. However, the determination may be performed not by the first swipe event but by initial several swipe events, and the horizontal components or the vertical components of the several swipe events are added and the magnitude of the integrated value may be compared.

### Other embodiments

The examples of using the touch panel display have been explained in the present embodiments. However, the present invention is not limited to the touch panel display. The present invention can be applied to a device capable of performing the shift in the vertical direction and the horizontal direction at the same time, such as a mouse including a trackball and a joystick, in the case where the display position is shifted (scrolled) in a page.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2012-277304, filed Dec. 19, 2012, 2013-250511, Dec. 3, 2013, which are hereby incorporated by reference herein in their entirety.

What is claimed is:

1. A display control apparatus, comprising
a control unit configured to control display position shift of an image expressed by image data depending on an attribute of an object included in the image data.

2. The display control apparatus according to claim 1, wherein the control unit performs control of suppressing the display position shift in a horizontal direction or in a vertical direction.

3. The display control apparatus according to claim 1, wherein the control unit controls the display position shift of an image corresponding to the object.

4. The display control apparatus according to claim 1, wherein the control unit controls the display position shift according to swipe operation.

5. The display control apparatus according to claim 1, further comprising
a determination unit configured to determine an attribute of an object to be displayed included in the image data, wherein the control unit suppresses display position shift in a direction perpendicular to a text direction, in a case where the attribute of the object to be displayed is determined to be a character attribute by the determination unit.

6. The display control apparatus according to claim 1, further comprising
a determination unit configured to determine an attribute of an object to be displayed included in the image data, wherein the control unit suppresses display position shift in a horizontal direction or a vertical direction, in a case where the attribute of the object to be displayed is determined to be a table attribute by the determination unit.

7. The display control apparatus according to claim 6, wherein the control unit suppresses display position shift of the table attribute object only in a vertical direction, in a case where the determination unit determines that the table attribute object has a row header and does not have a column header.

8. The display control apparatus according to claim 7, wherein the control unit suppresses display position shift of the table attribute object in a horizontal direction or a vertical direction, in a case where the determination unit determines that the row header is included in a display region.

9. The display control apparatus according to claim 6, wherein the control unit suppresses the display position shift of the table attribute object only in the horizontal direction, in a case where the determination unit determines that the table attribute object has a column header and does not have a row header.

10. The display control apparatus according to claim 9, wherein the control unit suppresses the display position shift of the table attribute object in the horizontal direction or the vertical direction, in a case where the determination unit determines that the table attribute object includes the column header in a display region.

11. The display control apparatus according to claim 1, further comprising
a determination unit configured to determine an attribute of an object to be displayed included in the image data, wherein the control unit does not suppress display position shift in any direction, in a case where the determination unit determines that the attribute of the object to be displayed is an attribute except a character attribute, a graphic attribute, and a table attribute.

12. The display control apparatus according to claim 1, further comprising
a detection unit configured to detect operation which instructs to perform control of the display position shift by the control unit, wherein
the control unit performs the control in a case where the operation is detected by the detection unit.

13. The display control apparatus according to claim. 1, further comprising
a display unit configured to display a display component indicating a direction in which suppression of the display position shift is performed by the control unit and a display component indicating a direction in which the suppression is not performed.

14. A display control apparatus, comprising:
an input unit configured to input image data including a plurality of objects;
a display unit configured to display an image expressed by the image data input by the input unit; and
a detection unit configured to detect a swipe operation for an image which is displayed by the display unit and corresponds to the object and, wherein
a direction of display position shift for the image which is displayed by the display unit and corresponds to the object is different depending on a type of the object, the display position shift being performed in response to the detection of the swipe operation by the detection unit.

15. A display control method, comprising
controlling display position shift of an image expressed by image data, depending on an attribute of an object included in the image data.

16. A non-transitory computer readable storage medium storing a program which causes a computer to perform the display control method according to claim 15.
